(19) United States
(12) Patent Application Publication
(10) Pub. No.: US 2018/0295864 A1
(43) Pub. Date: Oct. 18, 2018

(54) METHOD FOR CONVERTING ORGANIC BYPRODUCTS INTO FOOD-GRADE INGREDIENTS

(71) Applicant: Rise Products Inc., Brooklyn, NY (US)

(72) Inventors: Bertha Jimenez, Brooklyn, NY (US); Ashwin Goutham Gopi, Brooklyn, NY (US)

(21) Appl. No.: 15/954,688

(22) Filed: Apr. 17, 2018

Related U.S. Application Data
(60) Provisional application No. 62/486,118, filed on Apr. 17, 2017.

(51) Int. Cl. A23L 3/16; A23L 19/00; A23L 11/00; A23L 7/10; A23L 3/44; A23L 3/54; A23L 3/46

(52) U.S. Cl. CPC A23L 3/16; A23L 19/07; A23L 11/00; A23V 2002/00; A23L 3/44; A23L 3/54; A23L 3/46; A23L 7/115

(57) ABSTRACT

Method and systems are provided for processing organic byproducts is provided. The method includes separating the organic byproducts into solid components and liquid components and processing the solid components, wherein the processing the solid components includes pasteurizing the solid components, and dehydrating the solid components to form a first material. The method further includes processing the liquid components, wherein the processing the liquid components includes pasteurizing the liquid components, and dehydrating the liquid components to form a second material. The method additionally includes combining the first material and the second material to form a composite material.

### CLAIM OF PRIORITY

This application claims priority to U.S. Application No. 62/486,118 filed Apr. 17, 2017, which is incorporated herein by reference in its entirety.

### FIELD OF THE EMBODIMENTS

This invention relates to material processing and, in particular, to the processing of organic byproducts.

### BACKGROUND OF THE EMBODIMENTS

Organic byproducts from multiple industries contribute to millions of tons of waste each year in the United States alone. These organic byproducts are usually sourced from food and beverage manufacturers. Since these organic byproducts contain a large amount of moisture and nutrients, they are vulnerable to rapid spoilage due to microbial activity. Due to a lack of better options, these organic byproducts are disposed of in landfills or, at best, composted. Since they are not considered a traditional source of food waste, they are not subject to the EPA's food waste hierarchy. However, since they still contain a vast amount of nutrients, it could be argued that organic byproducts constitute the definition of food. A method to recover useful nutrients from homogenous sources of organic byproducts that helps overcome the problems related to preservation and stabilization of the material is thus needed.

Examples of related art are described below:

U.S. Pat. No. 4,341,805 generally describes a product for human consumption containing protein and having a high dietary fiber content and a low phytic acid content that is produced by drying brewer's spent grain, milling the dried brewer's spent grain to obtain a ground product having particle sizes ranging from about 600 microns down to about 50 microns and isolating the ground particles having a particle size of at least about 120 microns which constitute the product and contain about 18% to 22% protein and about 65% to 75% dietary fiber.

U.S. Pat. No. 4,828,846 generally describes a food product suitable for human consumption, having acceptable flavor and nutritional value, is recovered from cereal grain residues remaining after alcohol fermentation. The food product of the invention is produced by controlling the pH at a range of 4.0-5.0 of the various enzymic conversions of starch to alcohol using only certain organic and inorganic acids which avoid imparting unacceptable mineral acid tastes to the finished product. The preferred acid is citric acid. The pH of the slurry residues before drying to a finished product must be neutralized to about 5.0-8.0. Again, satisfactory taste of the finished product is achieved by carefully selecting the neutralizing agent, typically hydroxides or oxides of Na, K or Ca. Resulting products are characterized as containing only salts from acids used to adjust pH which are taste acceptable. The product forms a 1:10 aqueous suspension having a pH of about 5.0-8.0. In addition, the products include ions from the neutralizing agents, typically three times higher in concentration than concentrations for the same ions in the grain feedstock. The neutralizing ions are individually selected and are of such a concentration which produces food products that are acceptable in taste and are not toxic to humans.

U.S. Pat. No. 5,156,877 generally describes a protein-rich composition of brewer's spent grain origin which includes products separated from the husks of BSG and which contains 40 to 60% by weight of proteins, 12 to 18% by weight of lipids, 2 to 6% by weight of fibrous materials, and 1 to 4% by weight of ashes based on dry weight.

U.S. Pat. No. 5,260,092 generally describes a food material from the husk-free granular fraction of the spent grains of barley. The food product is substantially free of fermentable sugars and contains substantially all of the proteins originally in spent grains.

U.S. Patent Publication No. 2005/0147725 generally describes a nutritional and energy reduced fiber-based baking ingredient having a reduced glycemic index is intended for use in the baking industry, and comprises from 20% to 30% crude protein, from 50% to 80% fiber, up to 15% crude fat, and up to 2% of additional nutritional components chosen from the group consisting of lysine, amino acids, nutritional minerals, and mixtures and combinations. The reduced glycemic index fiber-based baking ingredient is derived from cereal grains chosen from the group consisting of wheat, barley, rye, corn, rice, oats, flax, and mixtures and combinations; and is initially derived as a by-product from the brewing or distilling industries. Breads, cookies, muffins, waffles, and nutribars, may be baked using the baking ingredient.

U.S. Patent Publication No. 2009/0175993 generally describes a process for obtaining a valuable product from plant material comprising both proteinaceous material and fibrous material includes brushing or scrubbing the plant material in a wet condition in a separation stage against a separation medium, thereby forcing proteinaceous material through the separation medium and retaining fibrous material on the separation medium, and withdrawing a fibre-rich product and a protein-rich product from the separation stage.

International Patent Publication No. WO2014106100A1 generally describes methods for the production of dough and bread products made at least in part of spent brewer's grain. The spent grain is removed from a brewing or distilling process, dried, frozen, and then further processed into a spent grain dough product. More specifically, the invention relates to the systems and methods for making frozen pizza dough balls composed at least in part of grain products that have been used in the process of brewing beer or distilling sprits such as whiskey.

None of the art described above addresses all of the issues that the present invention does. For example, the prior art in this topic has dealt with organic byproducts as a single material and not a system and process that can be adopted to process multiple types of materials. Additionally, the prior art does not describe a process that can handle multiple sources of organic byproducts through tracking and parallel processing.

### SUMMARY OF THE EMBODIMENTS

According to an aspect of the present invention, a method for processing organic byproducts is provided. The method includes separating the organic byproducts into solid components and liquid components and processing the solid components, wherein the processing the solid components includes pasteurizing the solid components, and dehydrating the solid components to form a first material. The method further includes processing the liquid components, wherein the processing the liquid components includes pasteurizing the liquid components, and dehydrating the liquid components to form a second material. The method additionally includes combining the first material and the second material to form a composite material.

According to another aspect of the present invention, a system for processing organic byproducts is provided. The system includes a separating apparatus configured to separate the organic byproducts into solid components and liquid components, one or more heating apparatuses configured to separately pasteurize the solid components and the liquid components, one or more dehydrating apparatuses configured to separately dehydrate the solid components, to form a first material, and the liquid components, to form a second material, and a container configured to enable the combining of the first material and the second material to form a composite material.

It is an object of the present invention to provide the method for processing organic byproducts, wherein the method further includes milling the composite material to a predetermined size.

It is an object of the present invention to provide the method for processing organic byproducts, wherein the method further includes sifting the composite material after milling.

It is an object of the present invention to provide the method for processing organic byproducts, wherein the method further includes determining, after milling, if components of the composite material are of a desired size, and, if the components of the composite material are not of the desired size, re-milling the composite material.

It is an object of the present invention to provide the method for processing organic byproducts, wherein the processing the solid components further includes applying one or more food processing aids to the solid components.

It is an object of the present invention to provide the method for processing organic byproducts, wherein the one or more food processing aids are selected from the group consisting of: xylanase; cellulase; lignin-modifying enzymes; and acid cellulase.

It is an object of the present invention to provide the method for processing organic byproducts, wherein the processing the solid components further includes adjusting pH levels of the solid components.

It is an object of the present invention to provide the method for processing organic byproducts, wherein the dehydrating the solid components further includes freeze-drying the solid components.

It is an object of the present invention to provide the method for processing organic byproducts, wherein the pasteurizing the liquid components includes applying microwaves to the liquid components.

It is an object of the present invention to provide the method for processing organic byproducts, wherein the organic byproduct includes brewer's spent grain, pomace, fruit pulp, and/or okara.

It is an object of the present invention to provide the method for processing organic byproducts, wherein the separating includes using equipment selected from the group consisting of: a screw press; and a centrifugation apparatus.

It is an object of the present invention to provide the system for processing organic byproducts, wherein the system further includes a milling apparatus configured to mill the composite material to a predetermined size.

It is an object of the present invention to provide the system for processing organic byproducts, wherein the system further includes a sifting apparatus for sifting the composite material after milling.

It is an object of the present invention to provide the system for processing organic byproducts, wherein the processing the solid components further includes one or more application devices configured to apply one or more food processing aids to the solid components.

It is an object of the present invention to provide the system for processing organic byproducts, wherein the one or more food processing aids are selected from the group consisting of: xylanase; cellulase; lignin-modifying enzymes; and acid cellulase.

It is an object of the present invention to provide the system for processing organic byproducts, wherein at least one of the one or dehydrating apparatuses is a spray drying apparatus.

It is an object of the present invention to provide the system for processing organic byproducts, wherein at least one of the one or more dehydrating apparatuses is a freeze-drying apparatus.

It is an object of the present invention to provide the system for processing organic byproducts, wherein at least one of the one or more heating apparatuses includes a microwave emitter.

It is an object of the present invention to provide the system for processing organic byproducts, wherein the organic byproduct includes brewer's spent grain.

### BRIEF DESCRIPTION OF THE DRAWINGS

FIG. 1 shows a system for separating and processing organic byproducts, according to an embodiment of the present invention.

FIG. 2 shows a system for milling and sifting processed organic byproducts, according to an embodiment of the present invention.

FIG. 3 shows a flowchart showing a method of processing organic byproducts, according to an embodiment of the present invention.

FIG. 4 shows a fatty acid profile of the resulting product, according to an embodiment of the present invention.

FIG. 5 shows an allergen and pathogen profile of the resulting product, according to an embodiment of the present invention.

FIG. 6 shows a nutrition profile of the resulting product, according to an embodiment of the present invention.

FIG. 7a-7c shows a profile of the resulting grain product, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Organic byproducts constitute a wide variety of materials. These materials may include, e.g., brewer's spent grain (BSG), a byproduct of the brewing process for beer.

The production of beer has not drastically evolved since its conception. The current brewing process can be considered inefficient since, for every liter of beer produced, there are approximately 200 grams of spent grain generated. In 2016, there were 200 million barrels of beer produced and consumed in the United States, leading to an approximate production and waste of 4.7 million tons of spent grain. Since beer is one of the most consumed beverages in the world, this is translated into billions of tons of leftover food every year.

BSG is the leftover malted barley that has been boiled and mashed during the brewing process. The brewing process removes the nutrients (e.g., the fermentable sugars) from the malt that is necessary to produce the wort. The leftover grain, the BSG, is considered as a lignocellulosic material rich in protein (approximately 25-30%, including exceptionally high levels of essential amino acids), fiber (approximately 28-35%), essential fatty acids (approximately 3-4%), minerals, and vitamins. Furthermore, it has significantly lower carbohydrates than regular all-purpose flour. Therefore, this material is very nutritious, and, when it is incorporated into a human diet, it can offer many benefits.

Among the advantages of BSG, it can reduce the risk of certain disease, which includes, e.g., cancer, gastrointestinal disorders, diabetes, and coronary heart disease. Unfortunately, BSG is not commonly used for consumption. The common practice for managing BSG, especially in urban environments, is to discard the BSG into landfills.

Another organic byproduct is okara. Okara is the residue left from ground soybeans after extraction of the water extractable fraction used to produce soy milk and tofu, a historic staple for many parts of Asia. In 2017, the top 10 soybean producing countries produce approximately 287.1 million metric tons of okara annually. The sheer amount of okara produced each year presents a significant disposal problem and an underutilized nutritional resource. While some okara is sometimes used as animal feed, a majority of the okara produced each year is burnt as waste and dumped into landfills.

Okara's composition offers multiple nutritional benefits. Okara includes twice the dietary fiber content of soybeans and also includes a significant amount of protein for a vegetable product. Every 100 g of dry okara contains ˜54.3 g of dietary fiber (approximately 8% soluble and 92% insoluble), ˜33.4 g of protein, and only ˜8.5 g of fat. Soluble fiber offers protection against heart diseases and diabetes, as well as helps regulate weight and bowel movements. Insoluble fiber similarly helps regulate weight and digestive health. Protein has recently garnered much attention for its key role in building bones, muscles, cartilage, skin, and blood. Polyunsaturated fat, such as linoleic and linolenic acids, represents much of the essential fatty acids found in okara. These acids aid in the formation of healthy cell membranes and in the proper development and functioning of the brain and nervous system, among many other things. Furthermore, okara contains healthy levels of potassium, calcium, iron, manganese, and zinc, with low levels of sodium. The same properties also apply to fruit and vegetable pulp, which is the byproduct of the juice industry.

Another organic byproduct is pomace, from grapes. Grapes are one of the most harvested fruit crops in the world, with an estimated 60 million tons produced every year. Approximately 80% of this total production of grapes goes into wine-making. From that, the remaining ˜20%, or 9 million tons, is pomace. Grape pomace is the material that remains after the grapes have been pressed and consists of skins, seeds, pulp, leaves, and stems. Traditionally, pomace is incorporated as compost and mulch. Nonetheless, through an extraction process, it is possible to obtain its natural oil, polyphenols, citric acid, methanol, and ethanol. These components represent a source of nutrients and bioactive compounds used in cosmetics and pharmaceutical products as well as food ingredients.

The overall composition of grape pomace varies depending on the grape variety and ripeness. On average, grape pomace has a moisture content ranging from approximately 50%-72%, has an insoluble portion of lignin ranging from approximately 16.8%-24.2%, and has a protein content of approximately <4%. A further break down of its elements shows that seeds correspond to approximately 38%-52% of the dry material, grape skins correspond to approximately 65%, and stems correspond to approximately 1.4%-7%. The seeds and skins have a high phenolic content which is highly valued as a source of natural antioxidants. The phenolic amount present in seeds is approximately 41.5%-56.5%.

Phenolic compounds are known for their protective role against pathogens as well as for their properties for being anti-allergenic, anti-atherogenic, anti-inflammatory, anti-microbial, antioxidant, and cardioprotective. Currently, synthetic antioxidants are widely used to delay the rate of oxidation in foods such as butylated hydroxyanisole (BHA), butylated hydroxytoluene (BHT), and tert butylhydroquinone (TBHQ). However, due to concerns over food safety and various toxicological reasons, there has been a growing interest for the use of phenolic compounds as food antioxidants. The abundance of the material and its low cost recovery represents a great opportunity as an additive for food products and as a dietary supplement.

Given the benefits that can be derived from organic byproducts, recycling organic byproducts can produce a wide variety of beneficial products.

BSG contains approximately 77-85% water. Due to its high moisture content and its nutritional contents, this product is a very volatile material. BSG is thus predisposed to deteriorate rapidly due to microbial activity. The benefits of the BSG grain have been noted in many studies, yet there has not been a cost-efficient way to convert the spent grain into products. The most common practice is to recycle this material by donating it to farmers or by drying it to be preserved for longer periods of time. However, the material can only last up to 6 hours when it is wet. This means that it is only a consistent practice if the farmers are in the vicinity of the brewery facility. However, this is not the case most urban ecosystems.

Regarding urban environments, breweries have tried different alternatives to preserve the spent grain. The principal methods are: freeze-drying, oven drying, drum drying, and freezing. Different scholars have evaluated these methods, to analyze the effectiveness of each of them. Oven/rotary drying or freeze-drying have been found to be good methods to reduce the volume of the product while not altering the composition of the material. However, rotary drum drying could also be very energy-intensive. Oven drying has challenges of its own, because it is very labor intensive, and there is always the risk of toasting and burning the dried grains. Furthermore, freeze-drying could be economically unfeasible. In the case of freezing, this could have an effect on the composition of some of the remaining sugar of the grain. Alternative methods for drying include superheated steam, membrane filter pressing, and chemical preservations. These methods have shown to be better for preserving the nutrition and quality of the material. In the case of the superheated steam, it has energy efficient advantages. However, they are not feasible on an industrial scale.

Some studies report that consumption of okara in large quantities can have adverse effects because of the phytic acid in okara that can reduce calcium balance and the availability of some metal ions. Thus isolation and extraction of this phytic acid is crucial to the viability of okara for use in human consumption. Many modern methods of okara extraction forsake this element.

Because the production methods of soy milk vary, the ratio of water to beans ranges from approximately 8:1 to 10:1, consequently affecting the microbiological quality of the resulting okara, as well as its lifespan. Under aerobic conditions, okara spoils quickly. Conductive indirect-heat drying with agitation is considered a good choice to dry okara, but heat can compromise its protein properties. Treating okara with a high-voltage electric field is another method of improving the drying of okara, but as with electrical stimulations of any sort, the full scope of adverse health and environmental risks remains questionable.

Winemaking remains an art more than a science rooted on ancestral artisanal practices. The implementation of technology to minimize waste and rescue value-added components remains a big challenge. There is also the limitation about what are the best practices to handle and treat byproducts. Also, the optimal extraction of components depends on a selected practice either by the use of solvents, enzymes, infrared drying, and others.

For at least the stated reasons, a multi-step process is required to convert wet organic byproducts into dry flour on an industrial scale. Such a process is described herein.

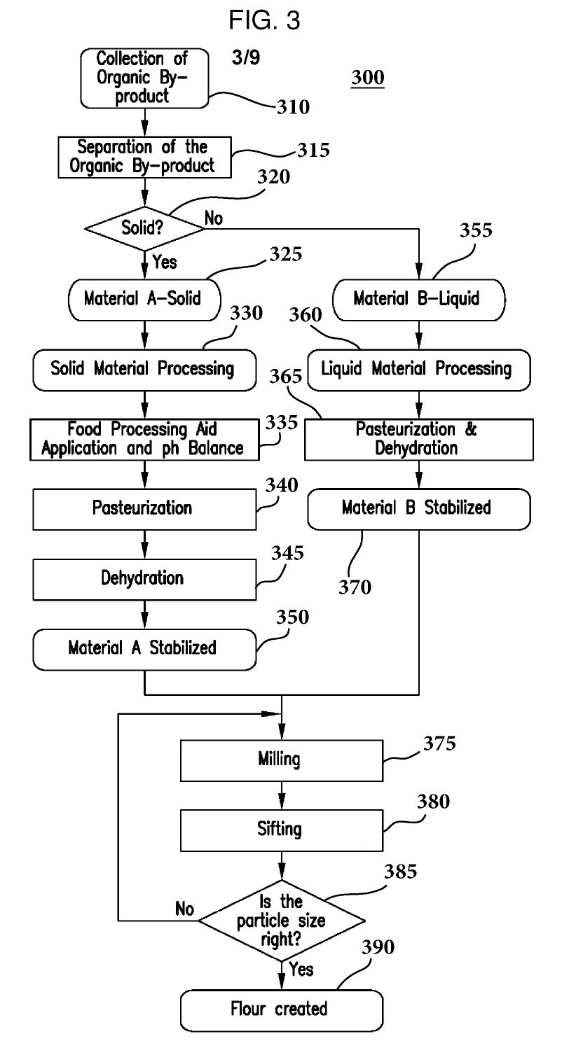

Referring now to FIG. 3, a flowchart showing a method 300 of processing organic byproducts is illustratively depicted, in accordance with an embodiment of the present invention.

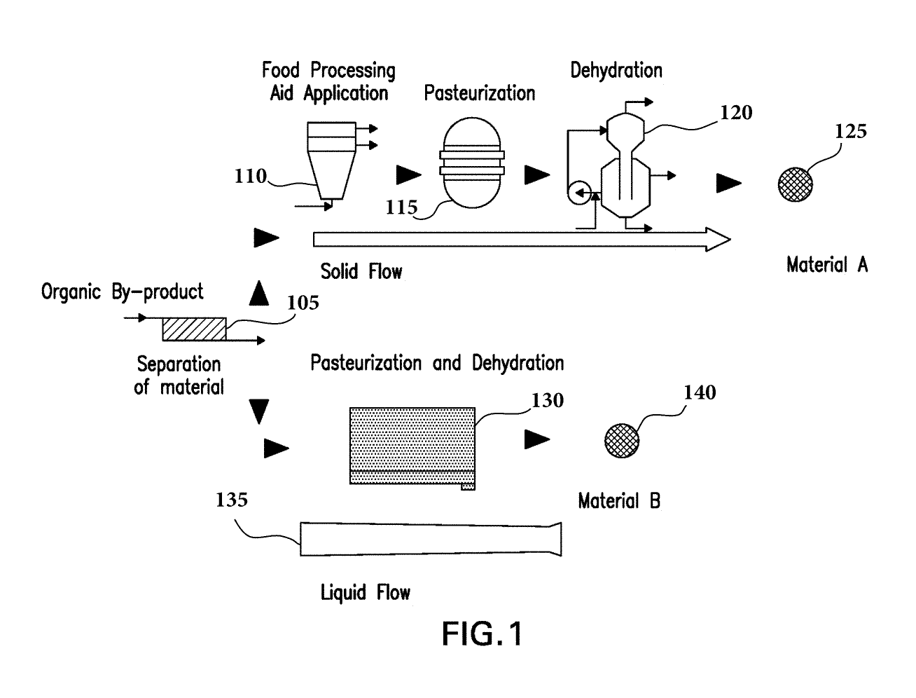

At step 310, an organic byproduct (105, shown in FIG. 1) is collected. According to an embodiment, the organic byproduct is spent grain. According to an embodiment, the spent grain is collected from a brewery as soon as the wort is extracted. At this stage, the spent grain is a warm and wet mash that can spoil rapidly. The shelf life of the spent grain at this phase is approximately six hours.

At step 315, the organic byproduct is separated into liquid and solid components (105, shown in FIG. 1). This separation can be done through different techniques such as, but not limited to, a screw press, a centrifugation apparatus, and/or any other suitable method for separating the organic byproduct into liquid and solid components.

According to an embodiment, a screw press separator is used. A screw press separator is a machine that uses a large screw that forces a material to go through a tube and pass a cylindrical screen. The typical flow of a screw press is approximately 180 to 662 liters/minute.

According to an embodiment, a higher supply flow rate is needed to ensure that the screw is always in contact with the full pipe. Typically, the rate of the supply ranges from approximately 450-750 L/min. According to an embodiment, a high back pressure of 800 PSI is used, with a screen of 250 microns.

According to an embodiment, a centrifuge is used to separate the organic byproduct into liquid and solid components. A centrifuge is a piece of equipment that uses rotation and sedimentation principles. The centripetal forces induce the separation of elements, depending on their density. This type of technology has been employed in the dairy and oil industry. This method could be used for the BSG.

By separating the material, a greater cost effective drying technique for the solid and liquid material can be achieved. The solid material contains mainly the fiber, while the liquid fraction contains the proteins, sugar, and vitamins.

At step 320, after separation, it is determined whether a material is a solid component or a liquid component.

If the material is determined to be a solid component, then, at step 325, the material is labeled as a solid (shown as “Material A-Solid”) and, at step 330, the solid material undergoes solid material processing. The solid material still contains nutrients that are trapped in the cellulose walls of the barley hull. At step 335, to release these nutrients, organic processing aids, such as enzymes, are required to use. There are different types of organic processing aids that could be used in this step, such as xylanase, cellulase, lignin-modifying enzymes or acid cellulase. (Example device 110 for administering food processing aid shown in FIG. 1). This type of enzyme improves the wet milling of the grain and increases flow characteristics. To apply the enzymes, pH of the material is changed from 7 (the typical pH. of BSG) to 5. According to an embodiment, a source of acid (such as ascorbic or citric acid) is needed to reduce the pH. According to an embodiment, the organic processing aid is then mixed with the solid part of the BSG for approximately 1-2 hours. Depending on the processing aid, approximately 0.25-1% (w/w) may be added to the mix.

After the period that the enzymes have interacted with the mix, the insoluble microcrystalline fibers of the hull break down into soluble sugars. Afterward, it is required to check the pH. of the material. The material should be balanced back to neutral (7). To achieve this, a base material, such as sodium bicarbonate, may be added.

At step 340, the solid material is pasteurized. Pasteurization is important to destroy microbial, fungus, and insect activities. Furthermore, it aids in making the aforementioned organic processing aid inactive. There are many ways to in which the solid material may be pasteurized. One such way to pasteurize the solid material is to place the solid material in a boiler/oven 115 (shown in FIG. 1) at approximately 90-100° C. for approximately 15-30 minutes. Another way the solid material may be pasteurized is by using steam. According to an embodiment, steam is allowed to flow through the solid material for approximately 15 to 30 minutes to ensure that the material is food grade. It is noted, however, that other forms of pasteurization may also be used while maintaining the spirit of the present invention.

At step 345, the solid material is freeze dried. Vacuum freeze-drying (freeze-drying apparatus 120 shown in FIG. 1) consists of dehydration by sublimation of a frozen product. Freeze-drying includes four stages: freezing, vacuum, sublimation and condensing. Microbiological activity and deterioration of the products are stopped given the absence of liquid water and the low temperatures needed for the process.

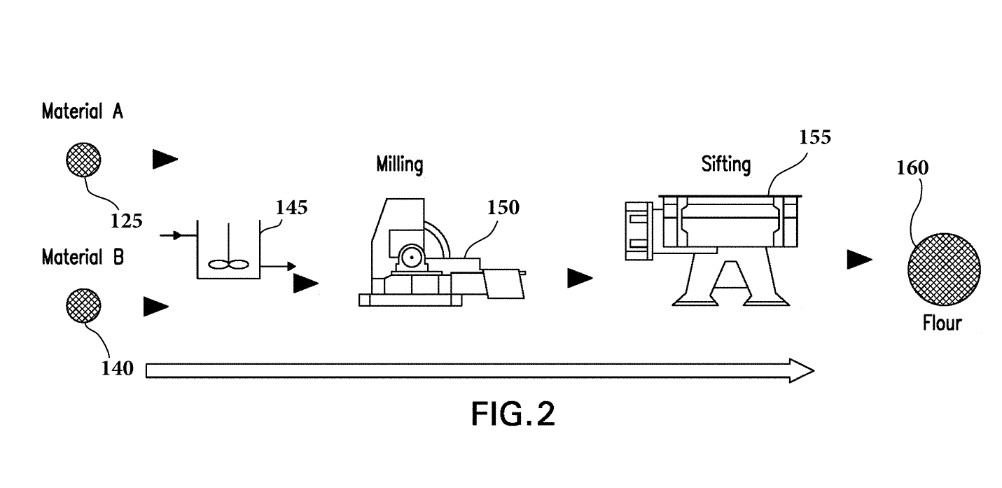

Freeze-drying provides a superior quality of the final product concerning taste, nutrition, and structure. In the context of BSG, freeze drying can safeguard the flavors of the material. Depending on the type of beer, the flavors may differ. The grains that come from a light beer such as an Ale or IPA will have flavors that are earthy and nutty; while a dark beer grain (such as a Porter or Stout) will have chocolate and coffee undertones. It is noted, however, that other method of dehydration may also be implemented while maintaining the spirit of the present invention. After the dehydration process, the solid material (at step 350) has been stabilized (stabilized Material A 125 shown in FIGS. 1-2). The stable material 125 has a shelf life of approximately 1-1.5 years.

If the material is determined to be a liquid component, then, at step 355, the material is labeled as a liquid (shown as “Material B-Liquid”) and, at step 360, the liquid material undergoes liquid material processing. The liquid material is the fraction that carries most of the nutrients. Pasteurization and dehydration (step 365) are needed to stabilize the material. One or more methods may be employed for performing the pasteurization and dehydration. These methods include, e.g., microwave drying, spray drying, drum drying, and/or any other suitable method that may be used while maintaining the spirit of the present invention.

According to an embodiment, microwave drying is used. Microwave drying (microwave 130 shown in FIG. 1) uses electromagnetic energy at a frequency that ranges from approximately 300 MHz to 300 GHz. Since microwaves cannot complete the drying process, the microwave driving process may be complemented with another method to improve the efficiency of the process (i.e. vacuum or forced air). Steam will be generated from the microwave process. A basic technique that could be used to remove the water vapor generated by microwave drying may consist of passing air over the surface of the material.

Microwave drying provides several advantages. The first one is that pasteurization and drying are combining in this method. Furthermore, the steam generated by this process could be reused to pasteurize the solid fraction. Another advantage is that the microwave energy reduces the time for drying, given that it targets the internal residual moisture. Furthermore, this technique can reduce the nutrient degradation that may happen with conventional oven drying.

According to an embodiment, spray drying (SD) is used to remove water from a free flowing liquid mixture. The liquid may flow through a pipe 135 (shown in FIG. 1) or any other suitable containment unit. This flowing liquid material is then transformed into a powdered product. The SD aims to get rapid fluid removal with minimal negative impact on the production. There are four basic steps for SD: atomization, contact between droplets and hot gas, water evaporation, and gas-powder separation. This method is cheaper than microwave drying, and has been vastly used for food industry applications (i.e. coffee, milk, tea). However, the equipment requires a large area to achieve drying. Furthermore, if the material is oily (which is the case of the liquid portion of BSG), it will need additional preparation to remove the level of fats during the atomization. Finally, if spray drying is used, an extra pasteurization step may be necessary. After the drying step, the liquid material (at step 370) has been stabilized (stabilized Material B 140 shown in FIGS. 1-2). The stable material has a life shelf of approximately 1-1.5 years.

Once material A 125 and material B 140 have been stabilized, they can be reconstituted into a final product. Given that one material has more fiber and the other material has more protein, the final product may be customized. Thus, the final product may have more protein or more fiber. After determining the percentage of fiber and protein, the material is mixed and treated as an ordinary flour. (Container 145 containing mixed material 125, 140 shown in FIG. 2) According to an embodiment, the grain may be addressed as a conventional material to create a flour. Two steps are performed for this process: milling and sifting.

At step 375, milling is performed. Milling may be achieved through different types of equipment, such as, e.g., a hammer mill, a pin mill, and/or any other suitable tool and/or device. (Milling device 150 shown in FIG. 2) Hammer mills can reach a higher reduction in the size of the particles. Pin mills will achieve a slightly larger size of the particles. However, pin mills have a greater capacity than hammer mills.

At step 380, the flour is sifted to ensure that the material is be homogenous. The sifting may be completed using a variety of methods such as, but not limited to, using a screening machine 155 (shown in FIG. 2) that includes a motor to induce vibration and one or more sieves to cause particle separation. It is noted, however, that other methods of sifting may also be implemented while maintaining the spirit of the present invention.

At step 385, it is determined whether the particle size for a material is correct. If there are still some large-sized particles, the milling (step 375) and sifting (step 380) steps may be repeated for that material. If the particle sizes are correct, then, at step 390, the flour 160 (shown in FIG. 2) is created.

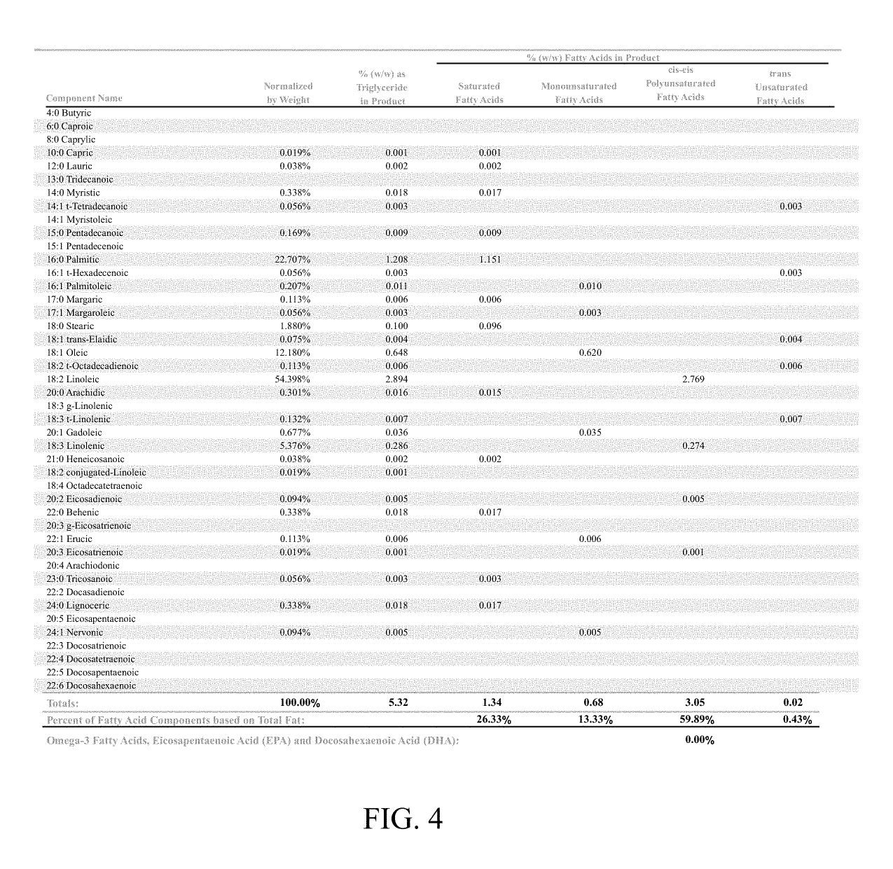

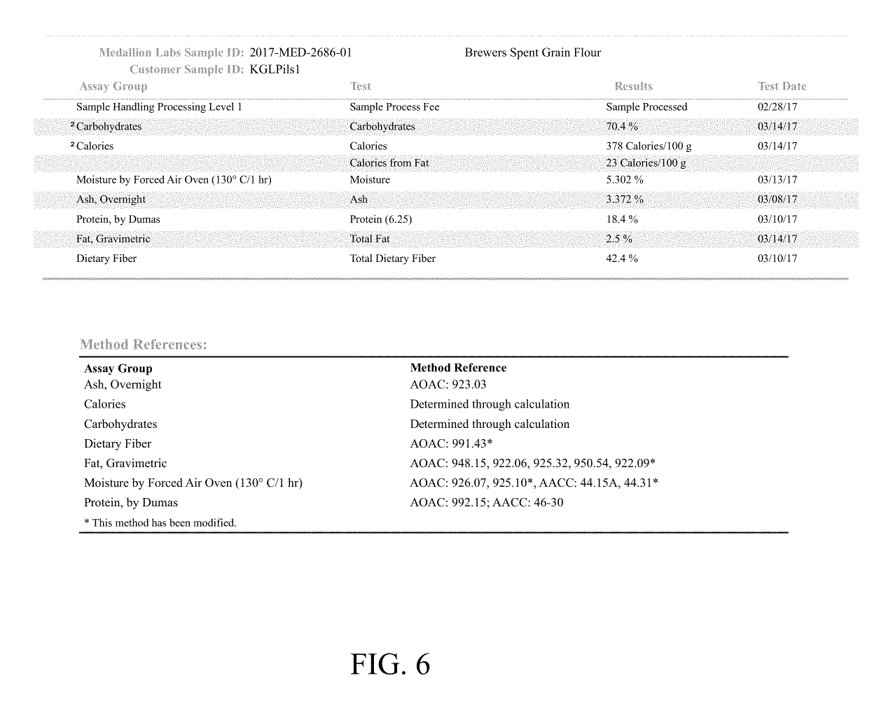

FIG. 4 shows a fatty acid profile of the resulting product, according to an embodiment of the present invention. In addition to nutrition prifle as described in FIG. 6, the high presence of fatty acids displays that the present invention's process is able to retain the specific aromas and taste associated with the input. When compared to traditional mechanical and thermal drying methods, the present invention's process is able to produce more valuable outputs.

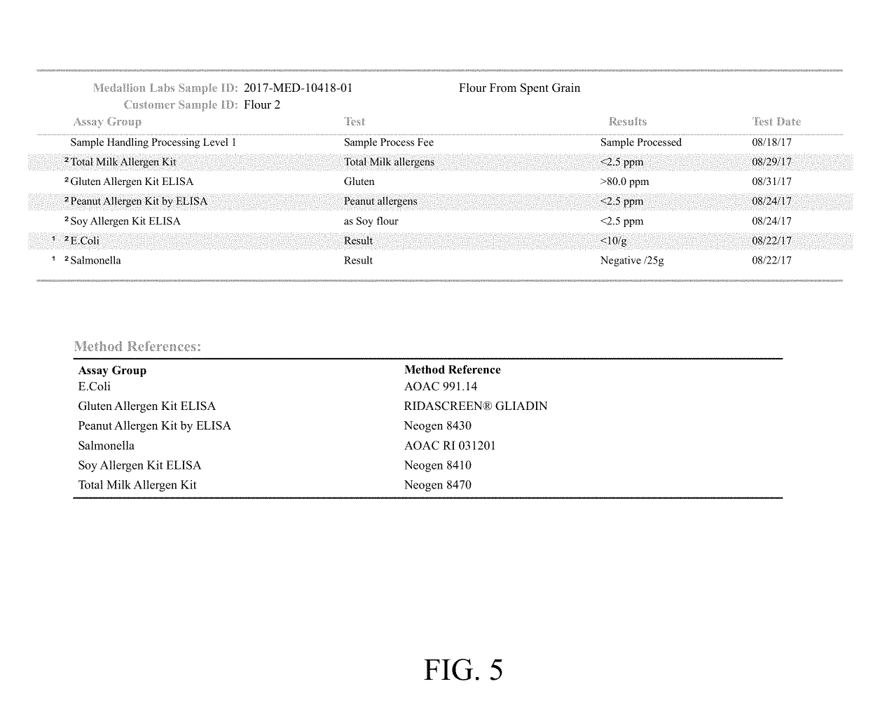

FIG. 5 shows an allergen and pathogen profile of the resulting product, according to an embodiment of the present invention. The pathogen test provided shows that in addition to low bioactivity, the pasteurization effect of the present invention's process eliminates common strains of bacteria that affect humans commonly associated with flour contamination. This includes salmonella and e-coli. The tests prove that the output of the present invention's process is safe for human consumption. The allergen test proves that the present invention's process is safe from cross-contamination from external sources of allergens. The only allergen discovered in the process's output is gluten, which is contained within the input: malted barley itself.

FIG. 6 shows a nutrition profile of the resulting product, according to an embodiment of the present invention. The nutrition tests prove that the present invention's process is able to recover and retain most of the valuable nutrition content of the raw materials. The high levels of organic compounds present is correlated with the temperate processing of the material, proving that the present invention's process does not destroy the nutrition of the input.

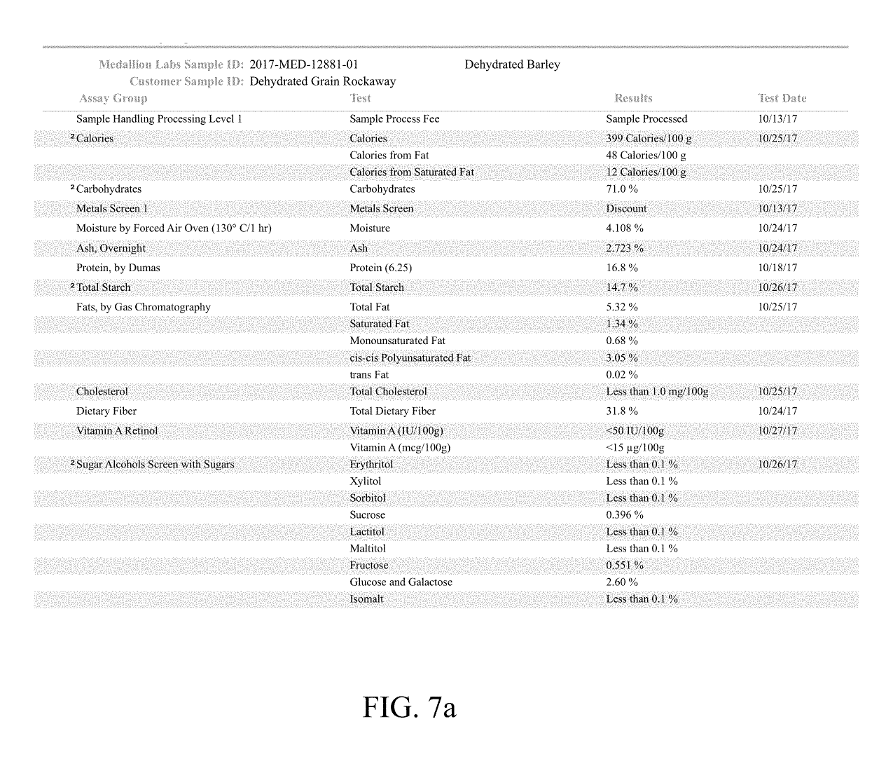

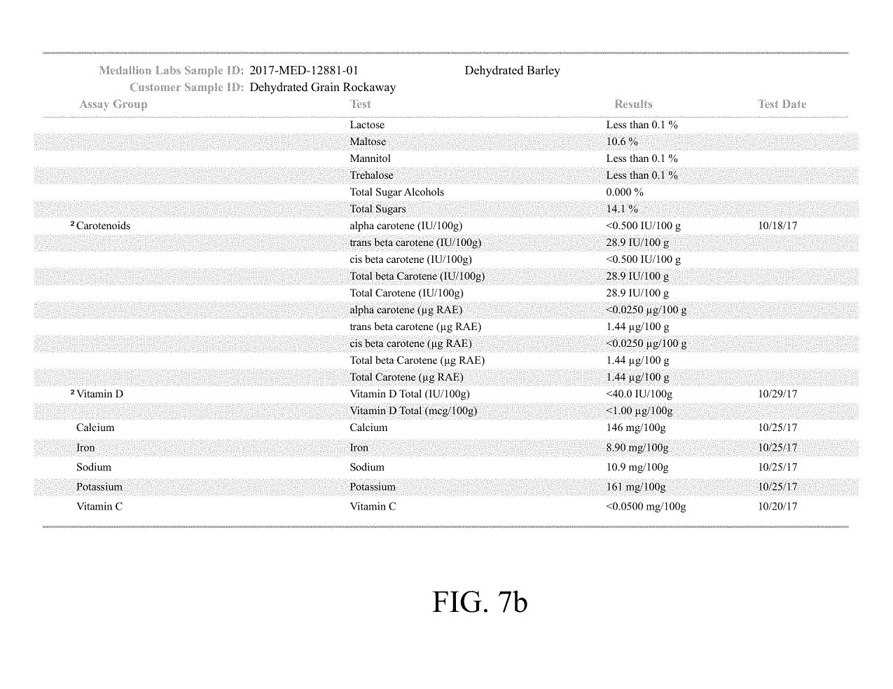

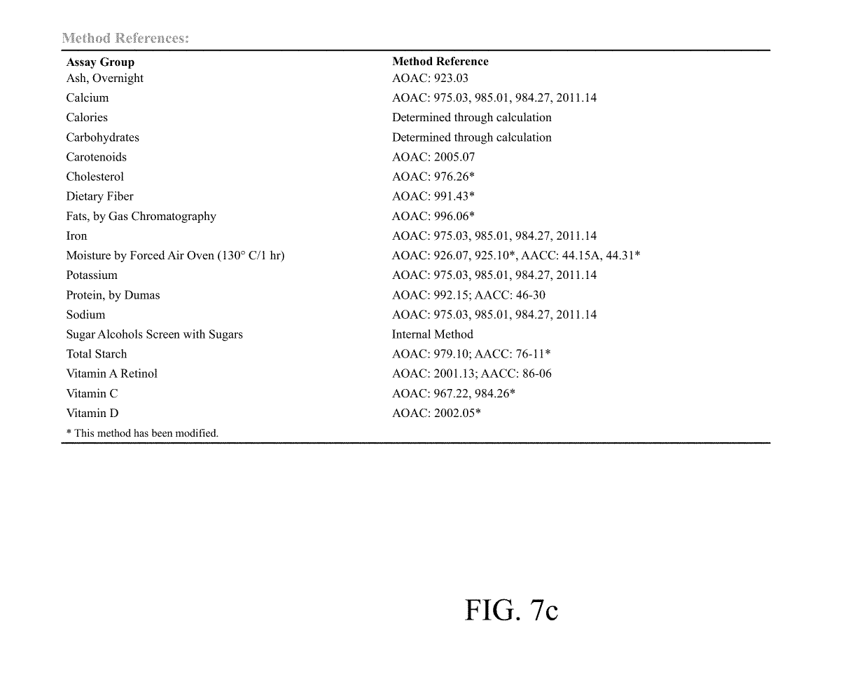

FIG. 7a-7c shows a profile of the resulting grain product, according to an embodiment of the present invention. The present invention's process generates dried grain containing 5% moisture. This is lower than any other grain, and can thus be stored for approximately 18 months. It speaks to the effectiveness of the present invention's process in addressing the main challenges of recycling organic byproducts: their short lifespan. By lowering the moisture content to less than 5%, the present invention's process ensures that bioactivity is effectively brought below hazardous levels.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for processing organic byproducts, comprising:
separating the organic byproducts into solid components and liquid components;
processing the solid components, wherein the processing the solid components includes:
pasteurizing the solid components; and
dehydrating the solid components to form a first material;
processing the liquid components, wherein the processing the liquid components includes:
pasteurizing the liquid components; and
dehydrating the liquid components to form a second material; and
combining the first material and the second material to form a composite material.

2. The method as recited in claim 1, further comprising:
milling the composite material to a predetermined size.

3. The method as recited in claim 2, further comprising:
sifting the composite material after milling.

4. The method as recited in claim 3, further comprising:
determining, after milling, if components of the composite material are of a desired size; and
if the components of the composite material are not of the desired size, re-milling the composite material.

5. The method as recited in claim 1, wherein the processing the solid components further includes:
applying one or more food processing aids to the solid components.

6. The method as recited in claim 5, wherein the one or more food processing aids are selected from the group consisting of: xylanase; cellulase; lignin-modifying enzymes; and acid cellulase.

7. The method as recited in claim 5, wherein the processing the solid components further includes:
adjusting pH levels of the solid components.

8. The method as recited in claim 1, wherein the dehydrating the solid components further includes:
freeze-drying the solid components.

9. The method as recited in claim 1, wherein the pasteurizing the liquid components includes:
applying microwaves to the liquid components.

10. The method as recited in claim 1, wherein the organic byproduct includes brewer's spent grain.

11. The method as recited in claim 1, wherein the separating includes using equipment selected from the group consisting of: a screw press; and a centrifugation apparatus.

12. A system for processing organic byproducts, comprising:
a separating apparatus configured to separate the organic byproducts into solid components and liquid components;
one or more heating apparatuses configured to separately pasteurize the solid components and the liquid components;
one or more dehydrating apparatuses configured to separately dehydrate the solid components, to form a first material, and the liquid components, to form a second material; and
a container configured to enable the combining of the first material and the second material to form a composite material.

13. The system as recited in claim 12, further comprising:
a milling apparatus configured to mill the composite material to a predetermined size.

14. The system as recited in claim 13, further comprising:
a sifting apparatus for sifting the composite material after milling.

15. The system as recited in claim 12, wherein the processing the solid components further includes:
one or more application devices configured to apply one or more food processing aids to the solid components.

16. The system as recited in claim 15, wherein the one or more food processing aids are selected from the group consisting of: xylanase; cellulase; lignin-modifying enzymes; and acid cellulase.

17. The system as recited in claim 12, wherein at least one of the one or dehydrating apparatuses is a spray drying apparatus.

18. The system as recited in claim 12, wherein at least one of the one or more dehydrating apparatuses is a freeze-drying apparatus.

19. The system as recited in claim 12, wherein at least one of the one or more heating apparatuses includes a microwave emitter.

20. The system as recited in claim 12, wherein the organic byproduct includes a material selected from the group consisting of: brewer's spent grain; pomace; okara; and fruit pulp.
